(19) United States
(12) Patent Application Publication
(10) Pub. No.: US 2017/0124673 A1
(43) Pub. Date: May 4, 2017

(54) System and Method of Scheduling Classes for a Timely Matriculation

(71) Applicant: Janet Lynn Tibberts, Greenwich, CT (US)

(72) Inventor: Janet Lynn Tibberts, Greenwich, CT (US)

(21) Appl. No.: 14/930,643

(22) Filed: Nov. 2, 2015

(51) Int. Cl. G06Q 50/20; G06F 7/08; G06F 3/0482; G06Q 10/10; G06F 3/0484

(52) U.S. Cl. CPC G06Q 50/2053; G06Q 10/1095; G06F 3/04842; G06F 3/0482; G06F 7/08

(57) ABSTRACT

A system and software for scheduling courses at an institution that offers a variety of courses in different semesters. Scheduling software is provided that is accessible to a student through a computer network. The scheduling software filters courses being offered by eliminating courses that have been previously completed by the student. Courses that do not serve as one of the student's course requirements are also filtered. Likewise, courses that have prerequisites yet unattained by the student are filtered. After the initial filtering process, the student is presented with filtered course offerings. The student selects courses from the filtered course offerings, therein creating scheduled courses. The scheduling software automatically updates the filtered course offerings after each selection of a course to eliminate any of the offered courses that conflict in date and time with scheduled courses.

### BACKGROUND OF THE INVENTION

1. Field of the Invention

In general, the present invention relates to software applications that are used to schedule classes in an institution of learning, such as a college or university. More particularly, the present invention relates to systems that track a student's progress in matriculating toward a selected degree in order to achieve the degree in the shortest, most cost efficient manner.

2. Prior Art Description

Most students that attend college, universities, and other institutions of higher learning attend classes in order to obtain a specific degree in a selected field of study. Most degrees are obtained by a student finishing the course requirements assigned to that degree. Often these course requirements are complex and require numerous classes in numerous fields of study. For example, an engineering student in a university with an engineering college may be required to take a certain number of engineering classes. Additionally, in order to achieve the degree, that same student may also have to take a certain number of liberal arts classes from the liberal arts college and business classes from the business college.

Students are required to schedule, attend, complete, and pass all the courses that are required for a degree. This often takes four years in the best of circumstances. However, in real life, many problems occur. Students often drop classes, change classes, or fail classes. This change to curriculum often happens after a semester has begun and most other classes are closed. As such, a student may end up taking fewer courses in a semester than he/she should. This produces a credit deficit in the matriculation process.

The problem becomes more complicated if a student drops, or fails a course that is a required course or a course that is a prerequisite to a required course. In this situation, the student must wait to take the same course. If the same course is not offered in the following semester, the student's graduation can be delayed. A student may have to attend a summer session or stay in school for an additional semester in order to graduate. This requires that the student pay additional tuition and related expenses.

Furthermore, many students change majors while in college. This can set back a student multiple semesters if all of the course accomplished for the initial degree do not transfer, or are not required, for the new second degree. The result is, again, that the student must stay in school longer and pay additional tuition.

On the opposite side of the spectrum, many students use advanced placements credits, job experience credits, and the like to matriculate toward a degree. This may enable a student to graduate a semester or two earlier than initially planned. This can save a student many thousands of dollars in tuition and related expenses.

It is often very difficult for a student to properly prepare a schedule that enables the student to matriculate to a degree in the optimum period of time. This planning is often greatly complicated by dropping classes, failing classes, encountering classes that are closed, and/or changing majors.

In the prior art, software systems have been developed that help a student schedule classes. Such prior art systems are exemplified by U.S. Patent Application Publication No. 2012/0046986 to Hannon, and U.S. Patent Application Publication No. 2014/0236854 to Strazzarino. Such prior art helps a student schedule classes so that the classes do not overlap. However, such systems do not help a student navigate the complications in scheduling that can advance or delay graduation.

A need therefore exists for a system and software application that can be used by a student that enables a student to schedule classes, while informing that student of how the selected classes affect the time and associated expenses required for graduation. This need is met by the present invention as described and claimed below.

### SUMMARY OF THE INVENTION

The present invention is a system and software for scheduling courses at an institution that offers a variety of courses in different semesters. In accordance with the invention, a computer database is maintained that contains a variety of courses and the course requirements needed for graduation in different majors and minors. The computer database is accessible through a computer network.

Scheduling software is provided that is accessible to a student through the computer network. The student uses the scheduling software to schedule courses for an upcoming semester. The scheduling software initially filters courses being offered by eliminating courses that have been previously completed by the student. Courses that do not serve as one of the student's course requirements are also filtered. Likewise, courses that have prerequisites yet unattained by the student are filtered. After the initial filtering process, the student is presented with filtered course offerings.

The student selects courses from the filtered course offerings, therein creating scheduled courses. The scheduling software automatically updates the filtered course offerings after each selection of a course to eliminate any of the offered courses that conflict in date and time with scheduled courses.

The courses are also prioritized so that a student has the best opportunity to schedule required classes without being closed out. In this manner, a student can matriculate in a timely fashion and achieve graduation on schedule.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic showing the hardware requirements of the present invention system and software;

FIG. 2 is a block diagram illustrating the methodology of the present invention system and software;

FIG. 3 is an exemplary embodiment of a scheduling display generated by the present invention system and software;

FIG. 4 shows the substeps involved in filtering, prioritizing and presenting classes in accordance with the present invention system and software; and

FIG. 5 shows prioritized selection menus generated by the present invention system and software.

### DETAILED DESCRIPTION OF THE DRAWINGS

Although the present invention system and software can be embodied in many ways, only one exemplary embodiment has been selected for illustration and discussion. The illustrated embodiment, however, is only exemplary and should not be considered a limitation when interpreting the scope of the appended claims.

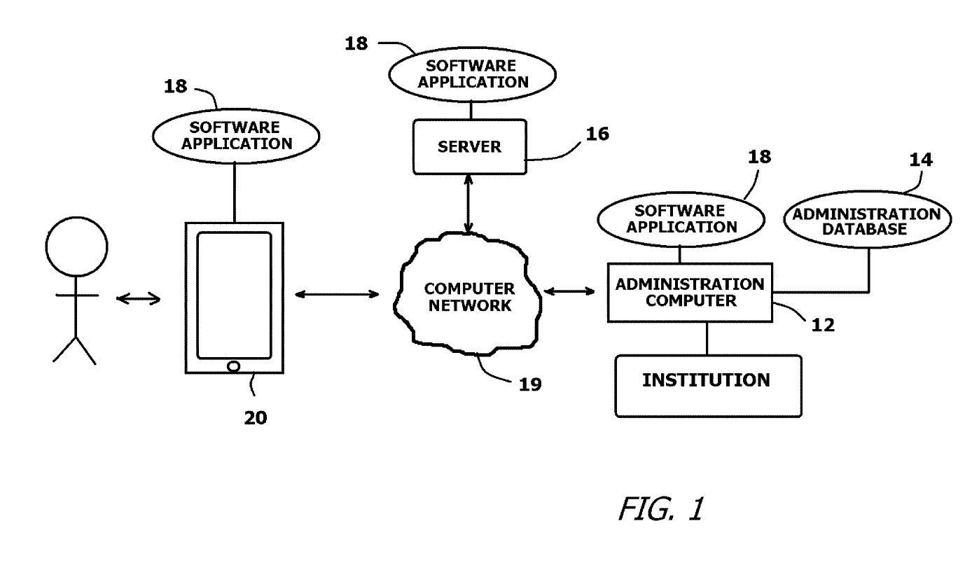

Referring to FIG. 1, the system requirements of the present invention system and software 10 are shown. Most institutes of higher learning have computer databases that contain information about the students enrolled at that institution. The databases also contain information regarding the courses offered by that institution and the matriculation requirements for various majors and minors. The administration computers 12 and the administration databases 14, communicate with one or more servers 16. The servers 16 run the server-end of specialized scheduling software 18 that will be described. The software 18 run by the servers 16 is accessed by students over a computer network 19 using student computers 20, such as a laptop, a tablet computer, or smart phone, that run the user end of the same software 18. The students typically access the server 16 through a password protected student portal. In this manner, only a student can access his/her own information at any time.

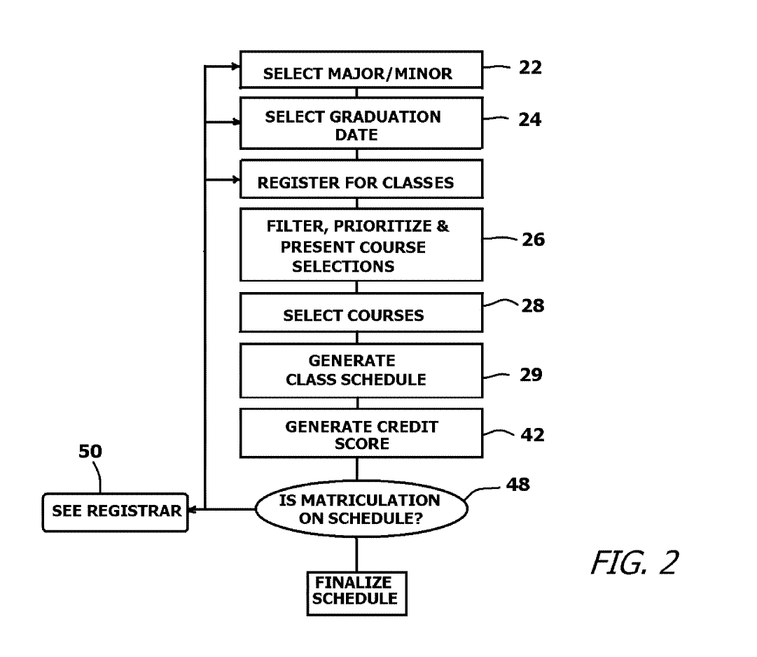

Referring to FIG. 2 in conjunction with FIG. 1, the methodology of the present invention can begin to be explained. The purpose of the present invention system and software 10 is to schedule courses for a student while simultaneously informing a student about how the selected courses affect matriculation goals. In this manner, a student can decide to take certain classes over others in order to stay on schedule for graduation.

As is indicated in Block 22, a student at an institute of higher learning selects a major and possibly a minor. The selected major/minor have course requirements needed to achieve a degree. These course requirements are stored in the administration databases 14. The student also selects a desired graduation date. See Block 24. If the student is working for a four-year degree, the graduation date will automatically be set to be four years from the student's enrollment. However, as will be later be explained in more detail, the student can selectively alter graduation date to an earlier date or to a later date.

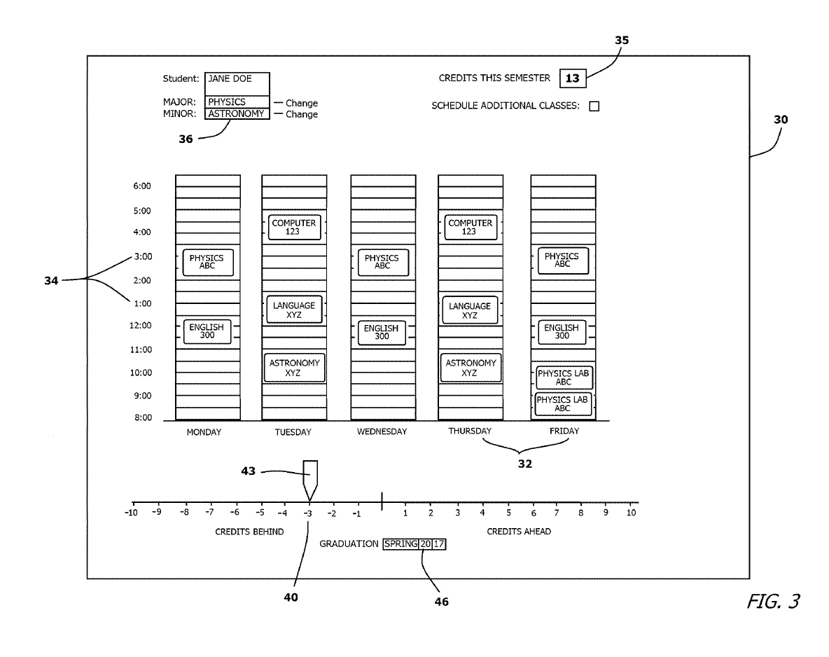

The student then prepares to register for courses and produces a class schedule. The system software 18 is accessed by the student. The system software filters, prioritizes, and presents courses to the student. See Block 26. The details of how the courses are filtered, prioritized, and presented are later described. The student uses the scheduling software 18 and the presented courses to select courses and generate a class schedule. See Block 28 and Block 29. The schedule produced by the systems software 18 is exemplified by the schedule display 30 shown in FIG. 3.

Referring to FIG. 3 in conjunction with FIG. 2, it can be seen that the schedule display 30 contains the traditional days of the week 32 and time of classes 34. The schedule display 30 also contains the declared minor and/or major 36 of the student. The declared major and minor 36 can be selectively altered for reasons that will later be explained.

Each declared major and minor has corresponding course requirements, which translate directly to course credit requirements. As a student selects courses, those selected courses appear on the schedule display 30. The courses are shown at their proper day and time. The total credits of the scheduled courses appear in a credit tally box 35. In the illustrated embodiment, it can be seen that student “Jane Doe” has scheduled thirteen (13) credits of classes.

As a student schedules classes, a credit score 40 is generated. See Block 42. The credit score 40 can be a number in a box. However, the Applicant prefers that the credit score 40 be shown as a graph. In FIG. 3, the credit score 40 is presented as a graph that is scaled from plus ten credits to minus ten credits. The value of the credit score 40 is ascertained by a sliding indicator 43 that shows a credit score of minus three (−3) credits.

The graduation date previously selected by the student (see Block 24) is displayed on the schedule display 30 in a date box 46. From the shown credit score 40, the student registering for classes can instantly tell that for her selected major and minor, she is three credits below what would be expected to graduate by the graduation date in the date box 46. The student, therefore, immediately knows that she should schedule another three credits if she wants to graduate on time without having to attend any summer sessions or specialty classes. See Block 48.

The scale of the credit score 40 is not arbitrary. If a student finds that he/she is more than ten credits behind schedule then that student may not be able to solve the problem by scheduling more classes. Rather, the student will either have to move back the graduation date, and/or change majors/minors.

Using the information of FIG. 3 as an example, the student is shown having a credit score deficit of three credits. If the student adds a semester by changing the graduation date in the date box 46 from Spring 2017 to Winter 2017, the credit score may change from negative three to plus nine. The student would therefore be ahead of requirements. Likewise, if the student drops the shown minor of astronomy and focuses only on the shown major of physics, then the requirements for graduation would change. The credit score may change from minus three to plus six. Again the student would be ahead of requirements.

Conversely, should a student change majors entirely, then the requirements for graduation change dramatically. The student may find herself more than ten credits behind. In such a scenario, a warning is sent to both the student and the registrar of the school. See Block 50. The proposed changes made by the student may require review by the school and/or counseling with a student advisor.

From the schedule of FIG. 3, it is known by the student that she needs three more credits to be on track for graduation. However, the student needs to know what three credits have to be taken. The three credits may be in her major, her minor, her particular college, or may be open electives.

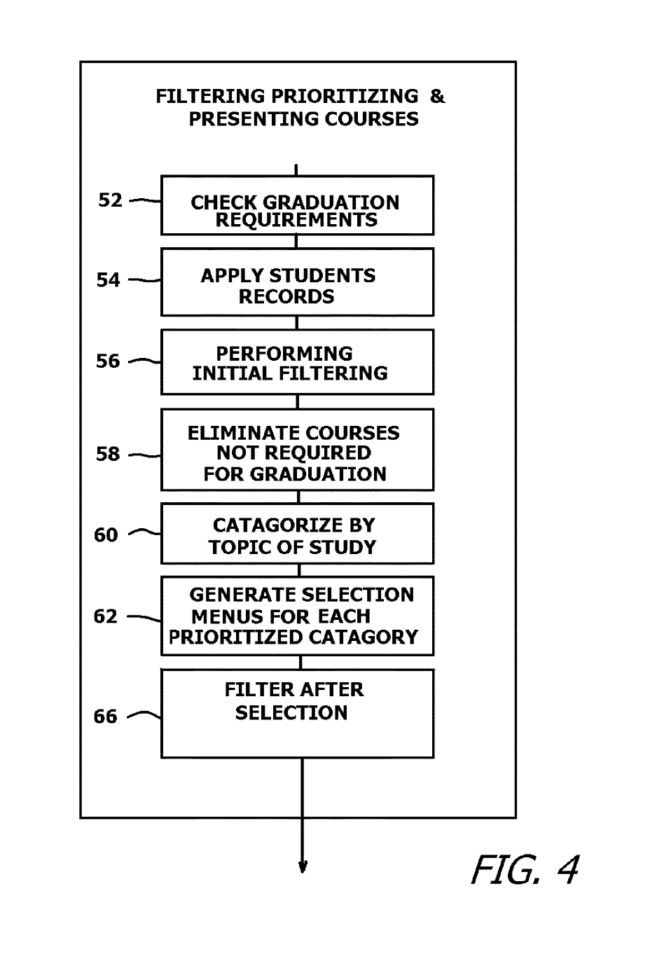

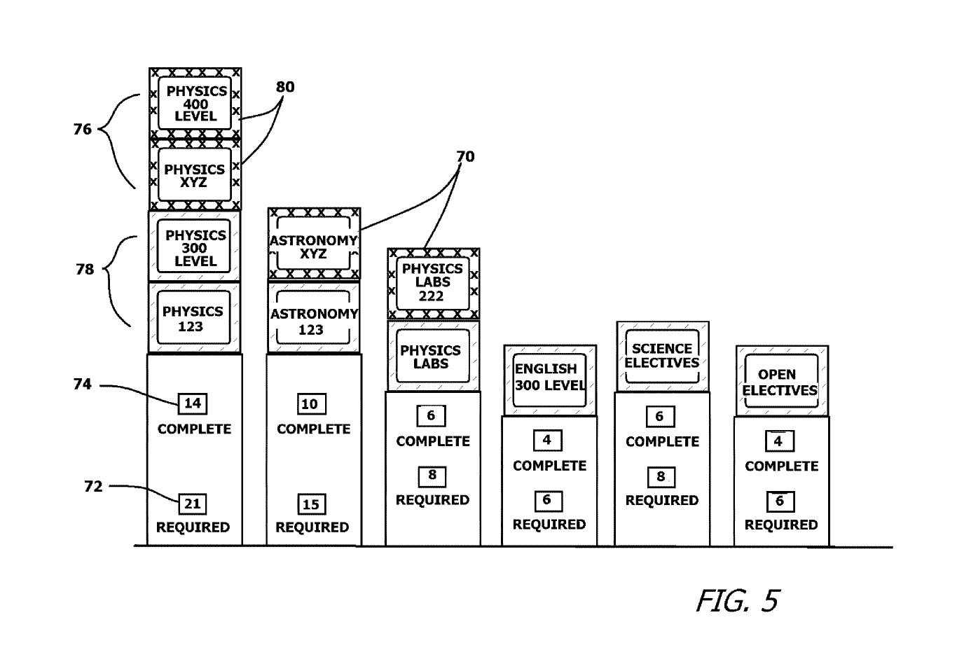

FIG. 2 shows the general step of filtering, prioritizing and presenting classes. See Block 26. The substeps involved in this general step are presented in FIG. 4. Some of the graphics used by the software in performing the substeps are shown in FIG. 5. As such, referring to both FIG. 4 and FIG. 5 in conjunction with FIG. 1, it can be seen that the general step of filtering, prioritizing and presenting courses requires that the graduation requirements be recalled for the major and minor of the student. See Block 52. The scheduling software 18 then accesses the student's records from the administration database 14 to determine what courses have been completed by the student. See Block 54. Knowing the course requirements needed for matriculation and the course requirements already met by the student, the course offerings are initially filtered and categorized. See Block 56.

During the initial step of filtering, courses that do not help a student achieve graduation are automatically eliminated from consideration. See Block 58. This creates filtered course offerings. The filtered course offerings are then categorized by topic of study. See Block 60. The categories are then prioritized. See Block 62. The category with the highest priority is the category that matches the stated major of the student. In the example case, that is physics. The category with the second highest priority is the category that correspond to the stated minor of the student. In the example case, that is astronomy. The category with the third highest priority is the category that corresponds with required non-major classes with the fewest selections available. The category with the fourth highest priority is the category that corresponds with required non-major classes with the second fewest selections available. This prioritization process continues through the topics of study for the required courses. The category with the lowest priority are free electives.

A selection menu 70 is generated and presented for each of the topics of study. See Block 64. The selection menu 70 for each of the topics of study conveys four primary pieces of information. Each selection menu 70 shows the required credits 72 in that topic of study that are required to achieve graduation. Each selection menu 70 shows the number of completed credits 74 in each topic of study that have been completed. Each selection menu 70 shows all the available courses in each topic of study 76 that are required to be completed for graduation. Lastly, each selection menu 70 shows which of the required courses 78 the student is eligible to take that semester, and which required course 80 are restricted.

Using FIG. 4 as an example, it can be seen that the student is a physics major. As such, the “physics” category is given the highest priority. In the physics category, the student is shown to need 21 physics credits. The student has only completed 14 credits. Thus, seven more credits are required for graduation. Given the courses completed by the student, the required courses for that student are presented. The required courses may be a specific course, such as Physics 123. Alternatively, the required courses may be selected from a course type, such as a course from the 300 level of courses. If this icon is selected, the 300 level physics courses being offered for that semester are presented.

Other required courses, such as Physics XYZ are also shown. However, if the student lacks the prerequisites needed to take this course, that course selection will be locked from selection. In the illustration of FIG. 4, these restricted courses are shown with x-ed borders. These courses, however, are shown to remind the student about the number and content of courses that must still be taken in the future to achieve graduation.

Using the selection menus 70, the student selects courses from the highest priority category to the lowest priority category. Once a course is selected by a student, that course is inset into the schedule display of FIG. 3. The initially filtered courses are again filtered before the next selection. See Block 66. The filtering is updated to eliminate all the courses from the offered schedule that conflict in time with the course that was just selected. Furthermore, some previously restricted courses may now become open if the selection of the initial course satisfies the prerequisite conditions.

Once the student selects courses from the major and minor, the required courses from lower prioritized categories are presented. The process is repeated until the student has a neutral or positive credit score 40 in the schedule display of FIG. 3.

Using the present invention system and software, a student can experiment with different majors and minors. This is especially useful to upperclassmen who may be able to achieve a minor by just picking up an extra class or two. The system and software are also very useful to underclassmen who are contemplating changing majors. Such students can quickly ascertain the requirements for a new major or minor and can determine if any change can be made without delay to graduation.

The present invention system and software can also help a student catch up, skip a semester, or graduate early if desired. Referring to Table 1 below, such a scenario is explained. From Table 1, it can be seen that to graduate, a student requires 120 course credits. Divided over eight semesters, this averages 15 course credits per semester. However, in the example shown in Table 1, the student is planning to skip the third semester. This may be planed for a trip, hospital procedure, church mission, internship or community service product.

TABLE 1

| | | | | STU- |
|---|---|---|---|---|
| | COURSE | CUMMULATIVE | CREDITS | DENT |
| SEMESTER | CREDITS | CREDITS | TAKEN | CREDITS |
| SEMESTER 1 | 15 | 15 | 18 | 18 |
| SEMESTER 2 | 15 | 30 | 18 | 36 |
| SEMESTER 3 | 15 | 45 | 0 | 36 |
| SEMESTER 4 | 15 | 60 | 18 | 54 |
| SEMESTER 5 | 15 | 75 | 20 | 74 |
| SEMESTER 6 | 15 | 90 | 18 | 92 |
| SEMESTER 7 | 15 | 105 | 15 | 107 |
| SEMESTER 8 | 15 | 120 | 15 | 122 |

The present invention system and software can adjust the students schedule to fit within only seven semesters. As can be seen, the fifteen course credits that are lost are spread out into the remaining semesters. The result is that the student can plan to skip a semester and still graduate on time.

Similarly, a student can use the present invention system and software to achieve a secondary degree in the shortest amount of time possible. Referring to Table 2 below, a student may be taking a two degree program that requires 135 course credits to complete. Using the traditional scheduling system this would take nine semesters, where fifteen course credits are taken per semester.

TABLE 2

| | | | | STU- |
|---|---|---|---|---|
| | COURSE | CUMMULATIVE | CREDITS | DENT |
| SEMESTER | CREDITS | CREDITS | TAKEN | CREDITS |
| SEMESTER 1 | 15 | 15 | 17 | 17 |
| SEMESTER 2 | 15 | 30 | 18 | 35 |
| SEMESTER 3 | 15 | 45 | 17 | 52 |
| SEMESTER 4 | 15 | 60 | 18 | 69 |
| SEMESTER 5 | 15 | 75 | 17 | 86 |
| SEMESTER 6 | 15 | 90 | 18 | 104 |
| SEMESTER 7 | 15 | 105 | 16 | 120 |
| SEMESTER 8 | 15 | 120 | 15 | 135 |
| SEMESTER 9 | 15 | 135 | 15 | 0 |

However, using the present invention system and software, the student can schedule an extra five credit courses in the each of the first three years. This adds the required fifteen credit courses. As such, the student can graduate in only eight semesters.

Furthermore, using the present invention system and software, students schedule classes from prioritized categories. Courses from majors and minors are selected first. Other courses are categorized by the number of courses being offered in the coming semester that meet a requirement. In this manner, the student's last choices of classes are the classes that are most common at the school. Consequently, the number of occurrences where a student is closed out of a class is reduced significantly. The occurrences where a student is closed out of a class in his/her major/minor should be eliminated.

The data gathered through the present invention system and software is also very useful to the administration of the school. By scheduling courses through the present invention system and software, the school can gather information of when different students in different majors and minor have openings in their schedules. For example, the administration may be able to determine that only 10% of physics majors have a class between 8:00 AM and 10:00 AM on Mondays and Wednesdays. This information is very useful to a department head. Using this information, the head of the physics department may schedule a class for Monday/Wednesday mornings as new classes are added to the semester. In this manner, the class will conflict with the fewest number of the schedules of physic majors.

The data from the present invention system and software is also useful in scheduling classes for a semester. If an administration can determine that many physics majors have negative credit scores, then the administration can add physics classes of various need levels to the courses being offered. Conversely, if an administration can see that many of the students have a high credit score in English classes, a few English classes can be removed from the course offerings.

It will be understood that the embodiment of the present invention that is illustrated and described is merely exemplary and that a person skilled in the art can make many variations to that embodiment. All such embodiments are intended to be included within the scope of the present invention as defined by the claims.

What is claimed is:

1. A method of scheduling courses for an institution that offers a variety of courses in different semesters and has various course requirements for graduation, said method comprising the steps of:
maintaining a computer database containing said variety of courses and said course requirements for graduation, wherein said computer database is accessible through a computer network;
providing a scheduling software that is accessible to a student through said computer network, wherein the student has a major and has previously completed some of a variety of courses offered by the institution;
having the student run said scheduling software to schedule courses for an upcoming semester, wherein said scheduling software initially filters said variety of courses available for selection by eliminating courses that have been completed by the student, eliminating courses that do not serve as one of said course requirements for said major of the student, and eliminating courses that have prerequisites yet unattained by the student, therein creating filtered course offerings;
having the student select courses from said filtered course offerings, therein creating scheduled courses, wherein said scheduling software automatically updates said filtered course offerings after each selection of a course to eliminate any of said variety of courses that conflict in date and time with scheduled courses.

2. The method according to claim 1, further including the step of categorizing said filtered course offerings, therein presenting said filtered course offerings in categories divided into topics of study.

3. The method according to claim 2, further including the step of indicating how many course credits are required in each of said categories to obtain said course requirements for graduation in said major of the student.

4. The method according to claim 3, further including the step of indicating how many course credits have been completed by the student in each of said categories.

5. The method according to claim 2, further including the step of prioritizing said categories from a category with a highest priority to a category with a lowest priority, wherein said scheduling software requires that the student select courses from said category with said highest priority first and progressing in selection toward said category with said lowest priority.

6. The method according to claim 5, wherein said step of prioritizing said categories includes making courses in said major of the student said highest priority.

7. The method according to claim 1, further including the step of having the student select a graduation date and indicating to the student whether or not said scheduled courses are sufficient to complete said course requirements for graduation by said graduation date.

8. The method according to claim 7, wherein said step of indicating to a student includes generating a credit score that indicates how many credits should be taken in the semester being scheduled to complete said course requirements for graduation by said graduation date.

9. The method according to claim 8, wherein said credit score is presented as a graph.

10. A method of scheduling courses for an institution that offers a variety of courses in different semesters and has various course requirements for graduation, said method comprising the steps of:
maintaining a computer database containing said variety of courses and said course requirements for graduation, wherein said computer database is accessible through a computer network;
having a student with a selected major run scheduling software through said computer network to schedule courses for an upcoming semester, wherein said scheduling software initially filters said variety of courses available for selection by eliminating courses that have been completed by the student, eliminating courses that do not serve as one of said course requirements for said major of the student, and indicating courses that have prerequisites yet unattained by the student, therein creating filtered course offerings;
categorizing said filtered course offerings into separate topics of study;
assigning priorities to said topics of study;
having the student select courses from said filtered course offerings using said priorities, therein creating scheduled courses, wherein said scheduling software automatically updates said filtered course offerings after each selection of a course to eliminate any of said variety of courses that conflict in date and time with scheduled courses.

11. The method according to claim 10, further including the step of indicating how many course credits are required in each of said topics of study to obtain said course requirements for graduation for said major of the student.

12. The method according to claim 11, further including the step of indicating how many course credits have been completed in each of said topics of study by the student.

13. The method according to claim 10, wherein said step of assigning priorities to said topics of study include prioritizing said topics of study from a highest priority to a lowest priority, wherein said scheduling software requires that the student select courses from said topic of study with said highest priority first and progressing in turn toward lowest priority.

14. The method according to claim 13, wherein said step of prioritizing said topics of study includes making courses in said major of the student said highest priority.

15. The method according to claim 10, further including the step of having the student select a graduation date and indicating to the student whether said scheduled courses are sufficient to complete said course requirements for graduation by said graduation date.

16. The method according to claim 15, wherein said step of indicating to a student includes generating a credit score that indicates how many credits should be taken in the semester being scheduled to complete said course requirements for graduation by said graduation date.

17. The method according to claim 16, wherein said credit score is presented as a graph.
